(19) United States
(12) Patent Application Publication
(10) Pub. No.: US 2016/0075138 A1
(43) Pub. Date: Mar. 17, 2016

(54) LIQUID DISCHARGE DEVICE, MOISTURE RETENTION CAP, AND METHOD FOR CLEANING INSIDE OF MOISTURE RETENTION CAP

(71) Applicant: FUJIFILM Corporation, Tokyo (JP)

(72) Inventor: Masahiko HASHIMOTO, Kanagawa (JP)

(73) Assignee: FUJIFILM Corporation, Tokyo (JP)

(21) Appl. No.: 14/954,088

(22) Filed: Nov. 30, 2015

Related U.S. Application Data
(63) Continuation of application No. PCT/JP2014/062293, filed on May 8, 2014.

(30) Foreign Application Priority Data
Jun. 14, 2013 (JP) 2013-125875

(51) Int. Cl. B41J 2/165

(52) U.S. Cl. CPC B41J 2/16505

(57) ABSTRACT

A liquid discharge device includes: a liquid discharge head that includes a nozzle surface on which a plurality of nozzles discharging liquid are disposed; a moisture retention cap that includes a liquid storage portion including a bottom surface inclined with respect to a horizontal plane and storing moisturizing liquid, a supply port supplying the moisturizing liquid to the liquid storage portion, and a discharge port provided on the bottom surface so as to be disposed below the supply port and discharging the moisturizing liquid, and retains the moisture of the nozzle surface; moving means for moving the liquid discharge head to an image formation position where the liquid discharge head discharges liquid to form an image on a medium and a standby position where moisture of the nozzle surface is retained; and moisturizing liquid controller controlling a level of the moisturizing liquid stored in the liquid storage portion.

### CROSS-REFERENCE TO RELATED APPLICATIONS

This application is a Continuation of PCT International Application No. PCT/JP2014/62293, filed on May 8, 2014, which claims priority under 35 U.S.C. §119(a) to Japanese Patent Application No. 2013-125875, filed on Jun. 14, 2013. Each of the above application(s) is hereby expressly incorporated by reference, in its entirety, into the present application.

### BACKGROUND OF THE INVENTION

1. Field of the Invention

The present invention relates to a liquid discharge device, a moisture retention cap, and a method for cleaning the inside of a moisture retention cap, and more particularly, to a maintenance technique for a moisture retention cap that is provided at a standby position of a liquid discharge head.

2. Description of the Related Art

In recent years, a demand for the printing of a small number of prints has increased in the printing industry. Since a plate needs to be formed in offset printing, there is a problem in terms of time and cost when the printing of a small number of prints is performed. For this reason, single path type inkjet recording is suitably used.

Further, the drying of ink in nozzles should be prevented in an inkjet recording device. For this purpose, the nozzle surface of a discharge head is covered with a moisture retention cap, in which moisturizing liquid is stored, during standby and humidity in the vicinity of nozzles is maintained in a desired range by the evaporation of the moisturizing liquid.

However, the moisturizing liquid stored in the moisture retention cap becomes contaminated due to ink adhering to the nozzle surface or the preliminary discharge of ink.

Accordingly, the inside of the moisture retention cap is regularly washed out or cleaned.

JP2008-238561A discloses a moisture retention cap that includes a discharge port provided at a position below the position of a supply port for a solvent in order to inhibit a solid component from remaining in a capping part that comes into contact with a discharge head.

Further, JP2009-101594A discloses a moisture retention cap of which a bottom surface is inclined and which includes a wiping blade wiping off thickening ink remaining on the surface thereof.

### SUMMARY OF THE INVENTION

However, there is a problem in that a cleaning time is long and the amount of a solvent used for cleaning is large in an inkjet printer including the moisture retention cap disclosed in JP2008-238561A.

Further, since an inkjet printer including the moisture retention cap disclosed in JP2009-101594A requires a mechanism for sliding the wiping blade, there is a problem in that the device is complicated and the cost of the device is increased.

The invention has been made in consideration of the above-mentioned circumstances, and an object of the invention is to provide a liquid discharge device and a moisture retention cap for which the frequency of regular cleaning can be reduced or regular cleaning does not need to be performed and which can be cleaned in a short time, and a method for cleaning the inside of the moisture retention cap.

In order to achieve the object, the invention provides a liquid discharge device including: a liquid discharge head that includes a nozzle surface on which a plurality of nozzles discharging liquid are disposed; a moisture retention cap that includes a liquid storage portion including a bottom surface inclined with respect to a horizontal plane and storing moisturizing liquid, a supply port supplying the moisturizing liquid to the liquid storage portion, and a discharge port provided on the bottom surface so as to be disposed below the supply port and discharging the moisturizing liquid, and retains the moisture of the nozzle surface; moving means for moving the liquid discharge head to an image formation position where the liquid discharge head discharges liquid to form an image on a medium and a standby position where moisture of the nozzle surface is retained; and a moisturizing liquid controller controlling a level of the moisturizing liquid stored in the liquid storage portion. The moisturizing liquid controller discharges the moisturizing liquid, which is stored up to a first level in the liquid storage portion, from the discharge port; supplies moisturizing liquid from the supply port while discharging the moisturizing liquid from the discharge port when the level of the moisturizing liquid becomes a second level; and stops the discharge of the moisturizing liquid from the discharge port while supplying moisturizing liquid from the supply port when the level of the moisturizing liquid becomes a third level.

In order to achieve the object, the invention provides a moisture retention cap that retains moisture of a nozzle surface of a liquid discharge head on which a plurality of nozzles discharging liquid are disposed. The moisture retention cap includes: a liquid storage portion that includes a bottom surface inclined with respect to a horizontal plane and stores moisturizing liquid; a supply port that supplies moisturizing liquid to the liquid storage portion; a discharge port that is provided on the bottom surface so as to be disposed below the supply port and discharges the moisturizing liquid; and a moisturizing liquid controller controlling a level of the moisturizing liquid stored in the liquid storage portion. The moisturizing liquid controller discharges the moisturizing liquid, which is stored up to a first level in the liquid storage portion, from the discharge port; supplies moisturizing liquid from the supply port while discharging the moisturizing liquid from the discharge port when the level of the moisturizing liquid becomes a second level; and stops the discharge of the moisturizing liquid from the discharge port while supplying moisturizing liquid from the supply port when the level of the moisturizing liquid becomes a third level.

Further, in order to achieve the object, the invention provides a method for cleaning the inside of a moisture retention cap. The moisture retention cap includes a liquid storage portion that includes a bottom surface inclined with respect to a horizontal plane and stores moisturizing liquid, a supply port that supplies the moisturizing liquid to the liquid storage portion, and a discharge port that is provided on the bottom surface so as to be disposed below the supply port and discharges the moisturizing liquid; and retains moisture of a nozzle surface of a liquid discharge head on which a plurality of nozzles discharging liquid are disposed. The method includes: a first step of discharging the moisturizing liquid, which is stored up to a first level in the liquid storage portion, to a second level from the discharge port; a second step of continuing to discharge the moisturizing liquid and supplying the moisturizing liquid from the supply port after the first step; and a third step of continuing to supply the moisturizing liquid and stopping the discharge of the moisturizing liquid from the discharge port when the level of the moisturizing liquid becomes a third level.

According to this aspect, the liquid storage portion of the moisture retention cap, which stores the moisturizing liquid, includes the bottom surface inclined with respect to the horizontal plane and is provided with the discharge port on the bottom surface at a position below the supply port for the moisturizing liquid. Accordingly, the moisturizing liquid contaminated with ink flows to the discharge port along the bottom surface.

Further, the moisturizing liquid, which is stored up to the first level in the liquid storage portion, is discharged from the discharge port; and moisturizing liquid is supplied from the supply port while the moisturizing liquid is discharged to the third level when the moisturizing liquid has been discharged to the second level. Since the moisturizing liquid is supplied from the supply port while the moisturizing liquid is discharged to the third level when the moisturizing liquid has been discharged to the second level, turbulence is generated in the moisturizing liquid of the liquid storage portion and the moisturizing liquid of the liquid storage portion is stirred and is discharged from the discharge port. Accordingly, since the liquid storage portion is cleaned, the moisturizing liquid of the liquid storage portion can become moisturizing liquid that has less ink dirt and is clean to some extent. Furthermore, it is possible to shorten a cleaning time and to reduce the amount of moisturizing liquid used for the cleaning of the liquid storage portion.

Therefore, according to this aspect, it is possible to provide a liquid discharge device and a moisture retention cap for which the frequency of regular cleaning can be reduced or regular cleaning does not need to be performed and which can be cleaned in a short time, and a method for cleaning the inside of the moisture retention cap.

Meanwhile, the third level may be lower or higher than the second level. It is preferable that the third level and the second level are different from each other in order to generate turbulence in the moisturizing liquid of the liquid storage portion when capability to discharge the moisturizing liquid and capability to supply the moisturizing liquid are constant.

In this aspect, it is preferable that the moisturizing liquid controller allows moisturizing liquid to be supplied from the supply port until the level of the moisturizing liquid becomes the first level when the level of the moisturizing liquid becomes the third level. Accordingly, it is possible to make the amount of moisturizing liquid, which is contained in the moisture retention cap before cleaning, be the same as that after cleaning.

In this aspect, it is preferable that the moisturizing liquid controller controls the level of the moisturizing liquid on the basis of a time calculated from capability to supply the moisturizing liquid and capability to discharge the moisturizing liquid. Alternatively, it is preferable that the liquid discharge device further includes a level sensor provided on the liquid storage portion and detecting the level of the moisturizing liquid stored in the liquid storage portion and the moisturizing liquid controller controls the discharge and supply of the moisturizing liquid on the basis of a detected value of the level sensor.

In this aspect, it is preferable that the liquid discharge device further includes a humidity sensor provided on the nozzle surface of the liquid discharge head and detecting humidity and the moisturizing liquid controller performs control of the level of the moisturizing liquid when a value of humidity lower than a predetermined value is detected in a case in which the liquid discharge head is present at the standby position. Alternatively, it is preferable that the moisturizing liquid controller performs control of the level of the moisturizing liquid at predetermined time intervals calculated on the basis of an evaporation time of the moisturizing liquid. It is possible not only to obtain moisturizing liquid, which has less ink dirt, but also to eliminate the reduction of a distance between the nozzle surface and the surface of the moisturizing liquid caused by the evaporation of the moisturizing liquid by performing the discharge and supply of the moisturizing liquid, which is performed by the moisturizing liquid controller, at any of these timings. Accordingly, it is possible to suitably maintain a moisture retaining effect.

In this aspect, the moisture retention cap may further include: a moisturizing liquid tank that stores moisturizing liquid; moisturizing liquid supply means for supplying the moisturizing liquid, which is stored in the moisturizing liquid tank, to the liquid storage portion; and a moisturizing liquid recovery tank that recovers the moisturizing liquid discharged from the liquid storage portion. Accordingly, it is possible to clean the inside of the moisture retention cap.

In this aspect, the liquid discharge device may further include: a filter that removes contamination in the moisturizing liquid stored in the moisturizing liquid recovery tank; and moisturizing liquid circulating means for supplying the moisturizing liquid, which has passed through the filter, to the moisturizing liquid tank. Accordingly, moisturizing liquid can be effectively used without being wasted.

According to the invention, it is possible to provide a liquid discharge device, a moisture retention cap, and a method for cleaning the inside of a moisture retention cap for which the frequency of regular cleaning can be reduced or regular cleaning does not need to be performed and which can be cleaned in a short time.

### BRIEF DESCRIPTION OF THE DRAWINGS

FIG. 1 is a side view of an inkjet recording device.

FIG. 2 is a plan view of the inkjet recording device.

FIGS. 3A to 3C are plan projection views showing examples of the structure of an inkjet head.

FIG. 4 is a cross-sectional view showing the three-dimensional structure of an ink chamber unit.

FIG. 5 is a view showing the structure of flow passages in a head module.

FIG. 6 is a block diagram showing the system configuration of the inkjet recording device.

FIG. 7 is a front view of the inkjet head and a moisture retention cap.

FIG. 8 is a front view showing the structure of the moisture retention cap.

FIG. 9 is a flowchart illustrating an operation for cleaning the moisture retention cap.

FIG. 10 is a side view showing the structure of main parts of the inkjet recording device.

FIG. 11 is a top view showing the structure of main parts of the inkjet recording device.

FIG. 12 is a perspective view of the moisture retention cap (moisture retention unit).

FIG. 13 is a cross-sectional view of the moisture retention unit and the inkjet head.

### DESCRIPTION OF THE PREFERRED EMBODIMENTS

Preferred embodiments of the invention will be described below in detail with reference to the accompanying drawings.

### First Embodiment

### Outline of Inkjet Recording Device

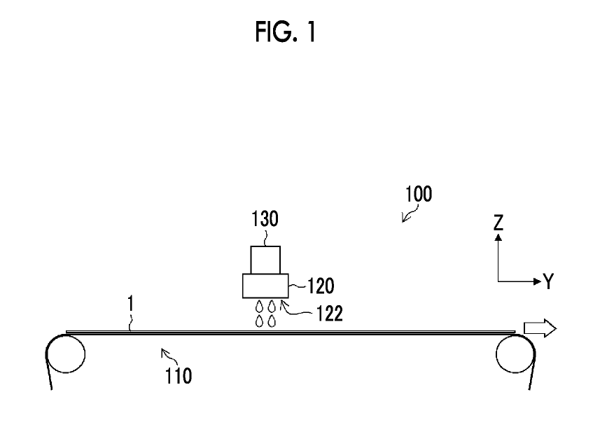

FIG. 1 is a side view of an inkjet recording device according to this embodiment. An inkjet recording device 100 is a printer that forms an image by discharging ink to a recording surface of a sheet 1 (an example of a medium (recording medium)), which is conveyed in a horizontal direction (Y direction) by a conveying unit 110 (an example of moving means), from a nozzle surface 122 of an inkjet head 120 (an example of a liquid discharge head).

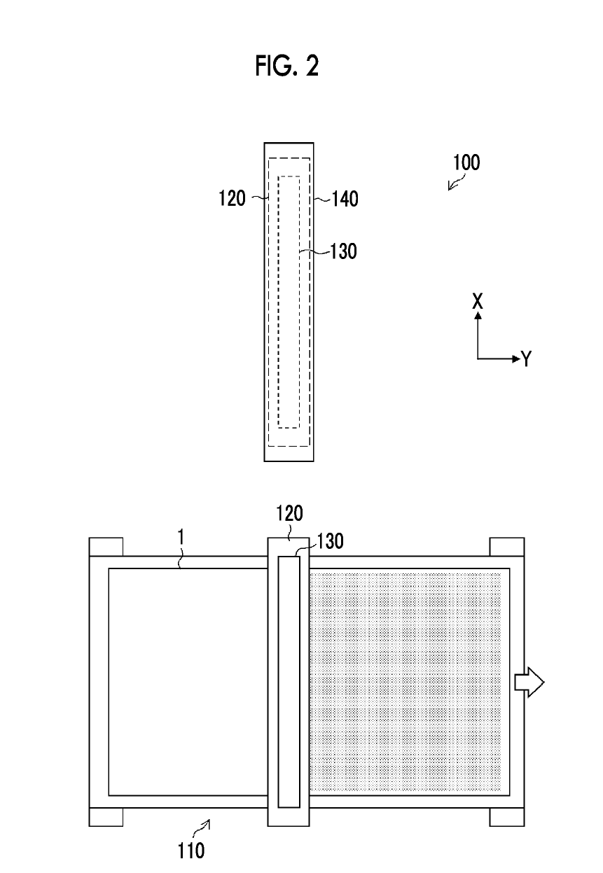

FIG. 2 is a plan view of the inkjet recording device 100. The inkjet recording device 100 includes a moisture retention cap 140 in a direction (an X direction) orthogonal to a conveying direction (Y direction) of the sheet 1 that is conveyed by the conveying unit 110.

The inkjet head 120 is held by a head holder 130 and is adapted so as to be capable of being moved in the X direction by a head moving mechanism (not shown). When the device is stopped for a long time, the inkjet head 120 is moved to a position (moisture retention position), which is close to the moisture retention cap 140 retaining the moisture of the nozzle surface 122, from a position where an image can be formed on the sheet 1 (image formation position) and the nozzle surface 122 is covered with the moisture retention cap 140. Accordingly, the non-discharge of ink, which is caused by drying, is prevented.

[Structure of Inkjet Head]

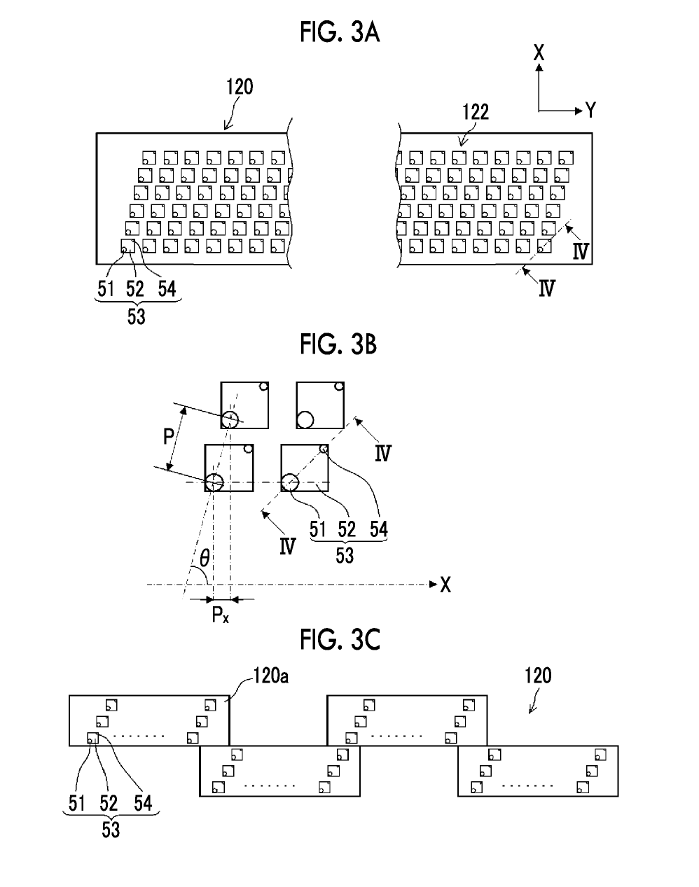

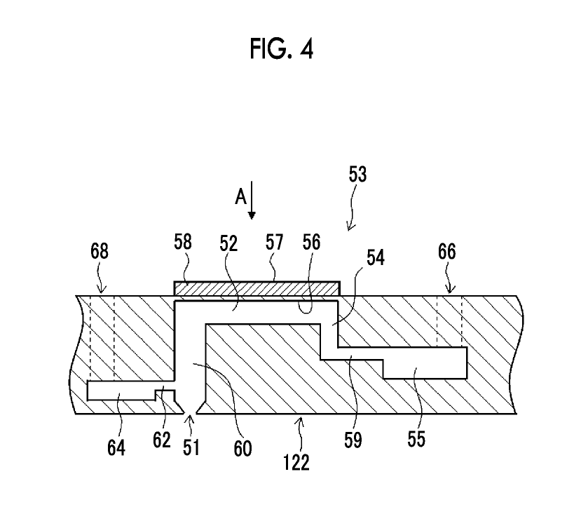

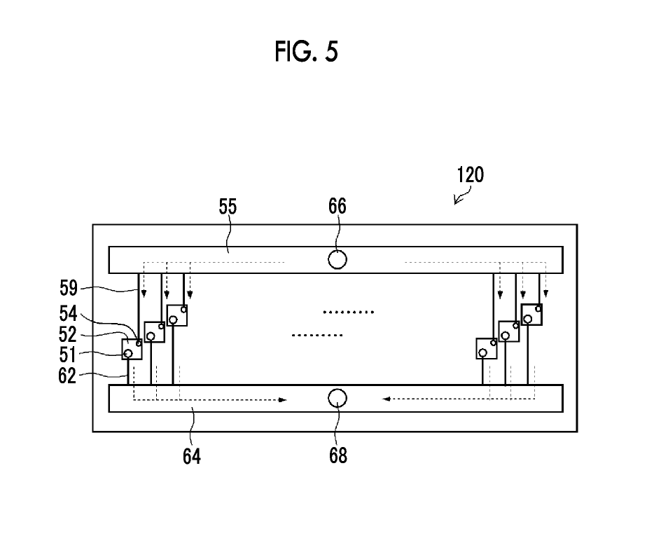

FIG. 3 is a view showing examples of the structure of the inkjet head 120. Here, FIG. 3A is a plan projection view seen from the nozzle surface 122, FIG. 3B is an enlarged view of a part of FIG. 3A, and FIG. 3C is a plan projection view of the entire inkjet head 120 that includes head modules 120a. Further, FIG. 4 is a cross-sectional view showing the three-dimensional structure of an ink chamber unit (a cross-sectional view taken along line IV-IV of FIGS. 3A and 3B), and FIG. 5 is a view showing the structure of flow passages in the head module 120a (a plan projection view seen in an A direction in FIG. 4).

The nozzle surface 122 (an example of a liquid discharge surface) of the inkjet head 120 is formed on a flat surface. Further, a plurality of nozzles 51, which are discharge holes for ink droplets, are disposed on the nozzle surface 122. It is necessary to reduce the pitch of the nozzles to reduce the pitch of dots formed on the sheet 1. The inkjet head 120 of this embodiment has a structure in which a plurality of ink chamber units 53, each of which includes a pressure chamber 52 and the like corresponding to each nozzle 51, are disposed (two-dimensionally) in a predetermined array pattern in the form of a matrix as shown in FIGS. 3A and 3B. Accordingly, the reduction of an actual interval (projected nozzle pitch) of the nozzles projected so as to be lined up in a longitudinal direction of the head (Y direction) is achieved.

Furthermore, the long inkjet head 120 including a nozzle array having a length corresponding to the entire width of a recording medium may be adapted so that short head modules 120a are arranged in a zigzag pattern and are connected to each other as shown in FIG. 3C. Although not shown, the long inkjet head may be adapted so that short head modules are lined up.

Meanwhile, an embodiment in which one or more nozzle arrays are formed over the length corresponding to the entire width of a recording medium in a direction substantially orthogonal to the sheet conveying direction is not limited to this embodiment.

The pressure chamber 52, which is provided so as to correspond to each nozzle 51, has a substantially square planar shape and includes a nozzle 51 and an ink inlet 54 provided at both corners on a diagonal line thereof. Each pressure chamber 52 communicates with an individual flow passage 59 (an example of a supply flow passage) through the ink inlet 54, and each individual flow passage 59 communicates with a common flow passage 55. Further, a nozzle flow passage 60, which communicates with each pressure chamber 52, communicates with a circulation common flow passage 64 through an individual circulation flow passage 62. The inkjet head 120 is provided with a supply port 66 (an example of a liquid supply port) and a discharge port 68 (an example of a liquid discharge port). The supply port 66 communicates with the common flow passage 55, and the discharge port 68 communicates with the circulation common flow passage 64.

That is, the supply port 66 and the discharge port 68 of the inkjet head 120 are adapted to communicate with each other through an ink flow passage (internal flow passage) that includes the common flow passage 55, the individual flow passage 59, the ink inlet 54, the pressure chamber 52, the nozzle flow passage 60, the individual circulation flow passage 62, and the circulation common flow passage 64. For this reason, a part of ink, which is supplied to the supply port 66 from the outside of the inkjet head 120, is discharged from each nozzle 51, and the rest of the ink passes through the common flow passage 55, the individual flow passage 59, the nozzle flow passage 60, the individual circulation flow passage 62, and the circulation common flow passage 64 in this order and is discharged to the outside of the inkjet head 120 from the discharge port 68.

It is preferable that the individual circulation flow passage 62 is connected to a portion of the nozzle flow passage 60 close to the nozzle 51 as shown in FIG. 4. According to this structure, since ink circulates near the nozzle 51, the thickening of ink present in the nozzle 51 is prevented. Accordingly, ink can be stably discharged.

A piezoelectric element 58 (an example of pressure generating means) including an individual electrode 57 is joined to a vibration plate 56 that forms the top surface of the pressure chamber 52 and serves as a common electrode. When a drive voltage is applied to the individual electrode 57, the piezoelectric element 58 is deformed and ink is discharged from the nozzle 51. When ink is discharged, new ink is supplied to the pressure chamber 52 from the common flow passage 55 through the individual flow passage 59 and the ink inlet 54.

In this embodiment, the piezoelectric element 58 is applied as discharge force generating means for ink that is discharged from the nozzles 51 of the inkjet head 120. However, a thermal method in which a heater is provided in the pressure chamber 52 and which discharges ink by using the pressure of film boiling that is caused by the heating of a heater can also be applied to this embodiment.

As shown in FIG. 3B, a plurality of ink chamber units 53 having the above-mentioned structure are arranged in a predetermined array pattern in the form of a lattice in a row direction parallel to a main scanning direction and a column direction that is inclined with respect to the main scanning direction by a predetermined angle θ without being orthogonal to the main scanning direction. As a result, a high-density nozzle head of this embodiment is realized.

That is, the pitch Px of the nozzles projected so as to be lined up in the main scanning direction satisfies “Px=P×cos θ” due to a structure in which a plurality of ink chamber units 53 are arranged with a constant pitch P in the direction inclined with respect to the main scanning direction by a certain angle θ. For this reason, in regard to the main scanning direction, the above-mentioned structure can be treated as a structure equivalent to a structure in which the respective nozzles 51 are linearly arranged with a constant pitch Px. A high-density nozzle structure in which the number of the nozzle arrays, which are projected so as to be lined up in the main scanning direction, reaches 2400 per inch (2400 nozzles/inch) can be realized by this structure.

Meanwhile, the disposition structure of the nozzles is not limited to the example shown in the drawings in this embodiment, and various nozzle disposition structures, such as a disposition structure that includes one nozzle array in a sub-scanning direction, can be applied.

[System Configuration of Inkjet Recording Device]

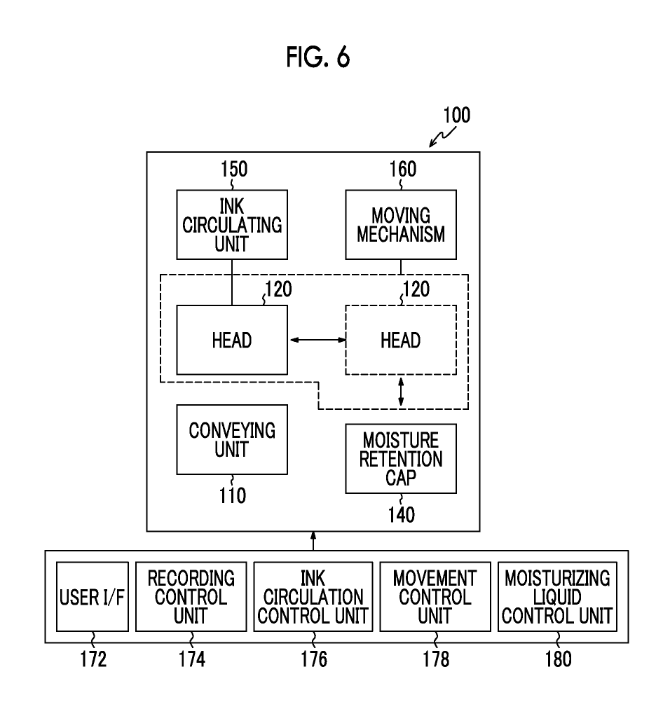

FIG. 6 is a block diagram showing the system configuration of the inkjet recording device 100. As shown in FIG. 6, the inkjet recording device 100 includes an ink circulating unit 150, a moving mechanism (moving means) 160, a user interface 172, a recording control unit 174, an ink circulation control unit 176, a movement control unit 178, a moisturizing liquid control unit 180, and the like in addition to the conveying unit 110, the inkjet head 120, and the moisture retention cap 140 that have been described above.

The ink circulating unit 150 (an example of circulating means) includes a pipe, a valve, an ink tank, a pump, and the like (not shown), and is connected to the inkjet head 120 through the valve. The ink circulating unit 150 supplies ink from the supply port 66 of the inkjet head 120. Further, the ink circulating unit 150 recovers ink, which is not discharged from the nozzles, from the discharge port 68 and circulates ink between the inkjet head 120 and the ink tank.

The ink circulating unit 150 circulates ink so that the back pressure of the nozzle 51 (the internal pressure of the inkjet head 120) becomes a negative pressure. Here, a negative pressure means a pressure lower than atmospheric pressure.

The moving mechanism 160 moves the inkjet head 120 to an image formation position or a moisture retention position. Further, the moving mechanism 160 is adapted to be capable of changing a distance between the inkjet head 120 and the moisture retention cap 140 as described below.

The user interface 172 includes an input section (not shown) that is used to operate the inkjet recording device 100 by a user and an output section (not shown) that is used to display a warning and the like, in addition to a power switch that is used to turn on/off the inkjet recording device 100 (to supply/cut off power to the inkjet recording device 100).

The recording control unit 174 (an example of image forming means) controls the conveyance of the sheet 1 that is performed by the conveying unit 110, the discharge of ink that is performed by the inkjet head 120, and the like, and forms an image on the recording surface of the sheet 1 on the basis of input image data.

The ink circulation control unit 176 controls the ink circulating unit 150 to control whether or not ink is circulated or the amount of ink to be circulated.

The movement control unit 178 controls the moving mechanism 160 to control the position of the inkjet head 120.

The moisturizing liquid control unit 180 (an example of moisturizing liquid controller) controls the level of moisturizing liquid 146 stored in a liquid storage portion 142 to be described below. Specifically, the moisturizing liquid control unit 180 controls the supply of the moisturizing liquid 146 into the moisture retention cap 140, the discharge of the moisturizing liquid 146 from the moisture retention cap 140, and the like.

[Structure of Moisture Retention Cap]

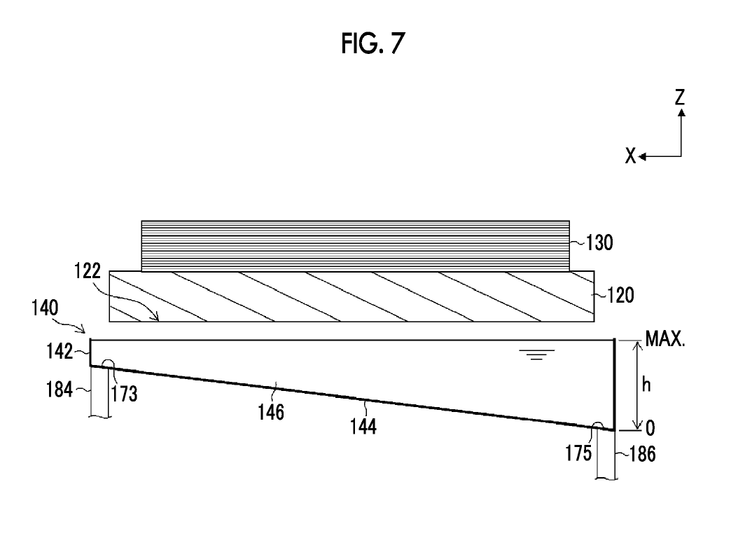

FIG. 7 is a view schematically showing the moisture retention cap 140 and the inkjet head 120 moved to the moisture retention position (standby position).

The liquid storage portion 142 is provided in the moisture retention cap 140. The moisturizing liquid 146, which moisturizes the nozzle surface 122 of the inkjet head 120, is stored in the liquid storage portion 142. The moisturizing liquid 146 is a liquid that contains the same solvent as a solvent for the ink discharged from the nozzles 51 of the inkjet head 120, and is a liquid that contains water as a main component.

Further, a bottom surface 144 of the liquid storage portion 142 is inclined with respect to a horizontal plane and a longitudinal direction of the inkjet head 120 (the X direction in FIG. 7).

Furthermore, the liquid storage portion 142 is provided with a supply port 173 that supplies the moisturizing liquid 146 into the liquid storage portion 142, and a discharge port 175 that discharges the moisturizing liquid 146 stored in the liquid storage portion 142. The discharge port 175 is disposed at a position lower than the height of the supply port 173 (a position lower than the height of the supply port 173 in a vertical direction), and is provided on the bottom surface 144. Moreover, it is preferable that the position of the supply port 173 is as far distant from the position of the discharge port 175 as possible.

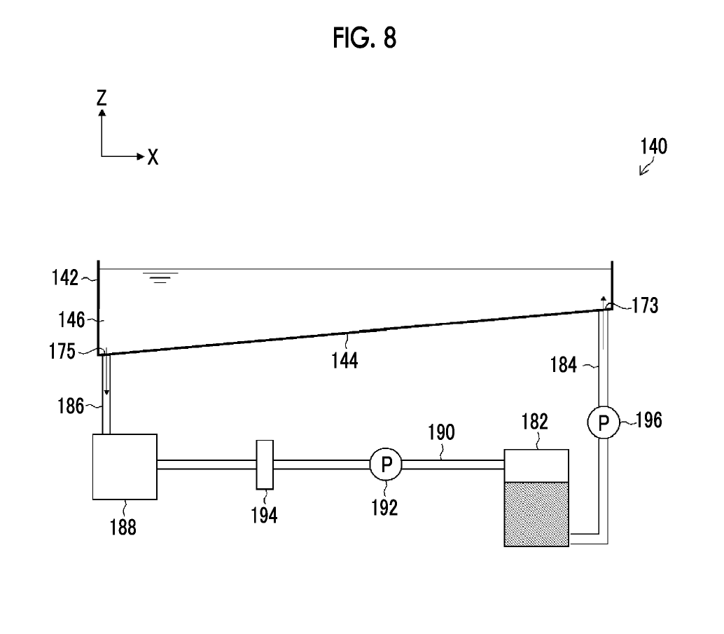

FIG. 8 is a front view showing an example of the structure of the moisture retention cap 140. As shown in FIG. 8, the moisture retention cap 140 includes a moisturizing liquid tank 182, a moisturizing liquid supply line 184, a moisturizing liquid discharge line 186, a liquid waste tank 188, a moisturizing liquid circulation line 190, a filter 194, and pumps 192 and 196, and the like.

Meanwhile, although not shown, a member for receiving overflowed moisturizing liquid, a discharge line for recovering the moisturizing liquid received by this member, and the like are provided outside the liquid storage portion 142.

Moisturizing liquid is stored in the moisturizing liquid tank 182. The moisturizing liquid may be cleaning liquid, and may contain a preservative that prevents the generation of fungi.

The moisturizing liquid tank 182 supplies moisturizing liquid to the liquid storage portion 142 through the moisturizing liquid supply line 184 at a constant flow rate by the pump 196.

The moisturizing liquid stored in the liquid storage portion 142 is made to flow by the pump 192, and is stored in the liquid waste tank 188 through the moisturizing liquid discharge line 186. Accordingly, the moisturizing liquid of the liquid storage portion 142 is discharged at a constant flow rate.

The moisturizing liquid, which is stored in the liquid waste tank 188, is introduced to the moisturizing liquid tank 182 through the moisturizing liquid circulation line 190 by the pump 192. The moisturizing liquid circulation line 190 is provided with a filter 194 that is used to remove foreign materials or dirt from the moisturizing liquid stored in the liquid waste tank 188.

When the moisture retention cap 140 is formed so as to have the above-mentioned structure, the liquid storage portion 142 of the moisture retention cap 140 can be filled with the moisturizing liquid. For this reason, the moisture of the nozzle surface 122 of the inkjet head 120 can be retained for a long time. Further, the moisturizing liquid is not wasted.

[Operation for Cleaning Inside of Moisture Retention Cap]

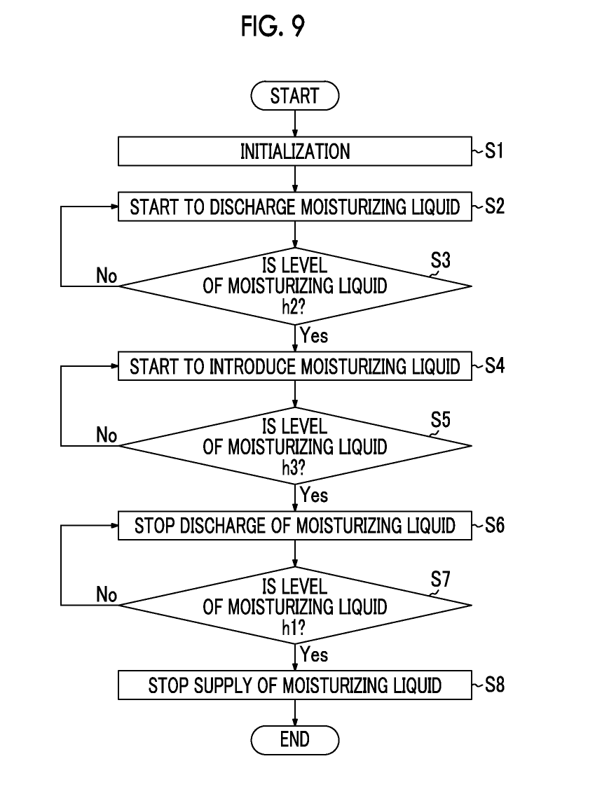

Next, an example of an operation for cleaning the moisture retention cap by the moisturizing liquid control unit 180 will be described with reference to a flowchart of FIG. 9.

(Step S1)

Initialization is performed. The inkjet head 120 is moved to the moisture retention position (standby position) where the moisture retention cap 140 is present.

(Step S2)

The moisturizing liquid 146 with which the liquid storage portion 142 is filled (in this embodiment, the level of the moisturizing liquid 146 is denoted by h1 (first level) when the liquid storage portion 142 is filled with the moisturizing liquid 146) starts to be discharged from the discharge port 175. Meanwhile, the first level h1 can be appropriately set without being limited to the level of the liquid when the liquid storage portion 142 is filled with the moisturizing liquid 146.

(Step S3)

It is determined whether or not the level of the moisturizing liquid 146 stored in the liquid storage portion 142 has become h2 (second level) by the discharge of the moisturizing liquid 146. That is, it is determined whether or not the moisturizing liquid 146 has been discharged until the level of the moisturizing liquid has become h2. The level h2 (second level) is lower than the level h1 (first level).

(Step S4)

When the level of the moisturizing liquid 146 stored in the liquid storage portion 142 becomes h2 (second level), the moisturizing liquid 146 starts to be supplied into the liquid storage portion 142 from the supply port 173. In this case, the moisturizing liquid 146 continues to be discharged.

(Step S5)

It is determined whether or not the level of the moisturizing liquid 146 stored in the liquid storage portion 142 has become h3 (third level) by the discharge and supply of the moisturizing liquid 146.

(Step S6)

If the level of the moisturizing liquid 146 stored in the liquid storage portion 142 has become h3 (third level), the discharge of the moisturizing liquid 146 from the discharge port 175 is stopped. In this case, the moisturizing liquid 146 continues to be supplied.

(Step S7)

It is determined whether or not the level of the moisturizing liquid 146 stored in the liquid storage portion 142 has become h1 (first level) by the supply of the moisturizing liquid 146.

(Step S8)

When the level of the moisturizing liquid 146 stored in the liquid storage portion 142 becomes h1 (first level), the supply of the moisturizing liquid 146 from the supply port 173 is stopped.

According to this embodiment, the liquid storage portion 142 of the moisture retention cap 140, which stores the moisturizing liquid 146, includes the bottom surface 144 that is inclined with respect to the horizontal plane and the longitudinal direction of the inkjet head 120, and is provided with the discharge port 175 at the position, which is lower than the supply port 173 for the moisturizing liquid 146, on the bottom surface 144. Accordingly, the moisturizing liquid 146 contaminated with ink flows to the discharge port 175.

The moisturizing liquid 146, which is stored up to the first level h1 in the liquid storage portion 142, is discharged from the discharge port 175 (first step), and moisturizing liquid 146 is supplied from the supply port 173 while the moisturizing liquid 146 continues to be discharged until the level of the moisturizing liquid 146 becomes the third level h3 when the moisturizing liquid 146 has been discharged to the second level h2 (second step). Turbulence is generated in the moisturizing liquid 146 of the liquid storage portion 142 by the second step, and the moisturizing liquid 146 of the liquid storage portion 142 is stirred and is discharged from the discharge port 175. Accordingly, since the liquid storage portion 142 is cleaned, the moisturizing liquid of the liquid storage portion 142 can become moisturizing liquid 146 that has less ink dirt and is clean to some extent.

Further, when the moisturizing liquid 146, which has less ink dirt and is clean to some extent, is stored up to the third level h3 in the liquid storage portion 142, the discharge of the moisturizing liquid 146 from the discharge port 175 is stopped and moisturizing liquid 146 is supplied until the level of the moisturizing liquid becomes the first level h1 (third step).

Accordingly, it is possible to shorten a cleaning time and to reduce the amount of the moisturizing liquid 146 to be used for the cleaning of the liquid storage portion 142.

According to this embodiment, the frequency of regular cleaning of the moisture retention cap 140 performed by a person can be reduced or regular cleaning of the moisture retention cap 140 does not need to be performed, and the inside of the moisture retention cap 140 can be cleaned in a short time.

Meanwhile, the third level h3 may be lower or higher than the second level h2. It is preferable that the third level h3 and the second level h2 are different from each other in order to generate turbulence in the moisturizing liquid 146 of the liquid storage portion 142 when capability to discharge the moisturizing liquid 146 and capability to supply the moisturizing liquid 146 are constant.

It is preferable that the second level h2 and the third level h3 are in the range of 20% to 80% of the first level h1.

For example, the second level h2 can be 60% of the first level h1 and the third level h3 can be 50% of the first level h1.

Meanwhile, a preferred second level h2 and a preferred third level h3 can be appropriately set according to the properties of the moisturizing liquid 146 to be used, the discharge capacity of the discharge port 175 of the liquid storage portion 142, the supply capacity of the supply port 173, the inclination angle of the bottom surface 144, and the like. Accordingly, it is preferable that the preferred second level h2 and the preferred third level h3 are determined through a preliminary experiment.

The levels h1 to h3 of the moisturizing liquid 146 of the liquid storage portion 142 can be calculated on the basis of a time that is calculated from the capability to discharge the moisturizing liquid 146 and the capability to supply the moisturizing liquid 146. Further, a level sensor (not shown) detecting the level of the moisturizing liquid 146 may be provided on the liquid storage portion 142, and the level of the moisturizing liquid 146 may be controlled on the basis of the detected value of the level sensor.

Further, it is preferable that the discharge and supply of the moisturizing liquid 146 performed by the moisturizing liquid controller 180 are performed as the operation of the moisture retention cap 140 performed by the moisturizing liquid control unit 180 when a value of humidity lower than a predetermined value is detected in a case in which a humidity sensor is provided on the nozzle surface 122 of the inkjet head 120 and the liquid discharge head is present at the standby position. Alternatively, it is preferable that the discharge and supply of the moisturizing liquid 146, which are performed by the moisturizing liquid controller 180, are performed (the level of the moisturizing liquid 146 is adjusted) at predetermined time intervals that is calculated on the basis of the evaporation time of the moisturizing liquid 146.

It is possible not only to obtain moisturizing liquid, which has less ink dirt, but also to eliminate the reduction of a distance between the nozzle surface 122 and the surface of the moisturizing liquid caused by the evaporation of the moisturizing liquid 146 by performing the discharge and supply of the moisturizing liquid 146, which is performed by the moisturizing liquid controller 180, at any of these timings, or to perform the discharge and supply of the moisturizing liquid 146 (to adjust the level of the moisturizing liquid 146) when detecting the reduction of humidity that is caused by a coating, such as latex, contained in ink. Accordingly, it is possible to suitably maintain a moisture retaining effect.

### Second Embodiment

### Structure of Inkjet Recording Device

Next, an inkjet recording device according to a second embodiment will be described below.

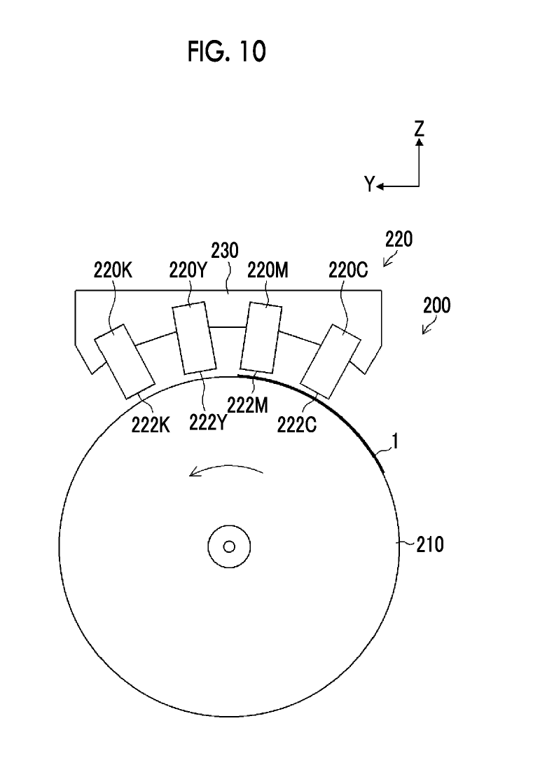

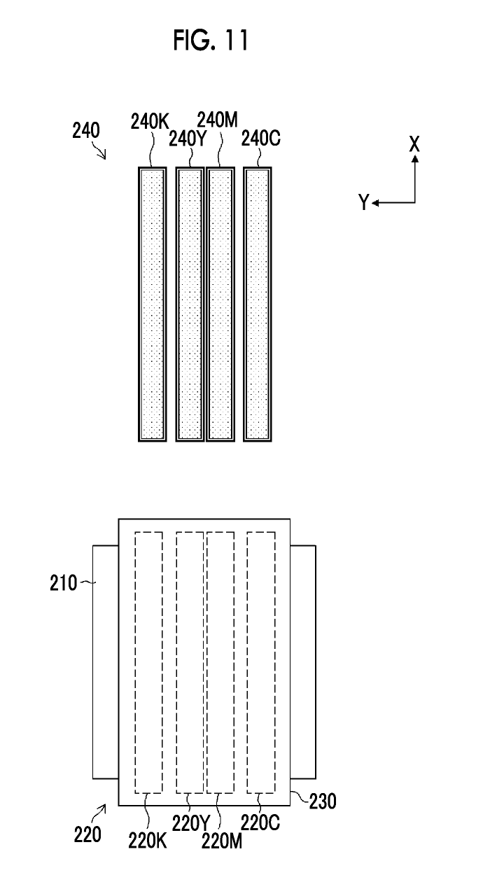

FIG. 10 is a side view showing the structure of main parts of the inkjet recording device according to this embodiment, and FIG. 11 is a top view thereof. As shown in FIGS. 10 and 11, an inkjet recording device 200 is a single path type line printer. The inkjet recording device 200 mainly includes: a conveying drum 210 that conveys a sheet 1 as a recording medium; a head unit 220 that discharges droplets of inks having colors of cyan (C), magenta (M), yellow (Y), and black (K) to the sheet 1 conveyed by the conveying drum 210; and a moisture retention unit 240 that retains the moisture of the respective inkjet heads mounted on the head unit 220.

The conveying drum 210 is rotated by being driven by a motor (not shown). A gripper (not shown) is provided on the outer peripheral surface of the conveying drum 210, and the sheet 1 is conveyed while an end of the sheet 1 is gripped by the gripper. A plurality of suction holes (not shown) are formed on the outer peripheral surface of the conveying drum 210, and air is sucked to the inside from the suction holes. The sheet 1 is conveyed while being sucked and held on the suction holes.

The head unit 220 includes: inkjet heads 220C, 220M, 220Y, and 220K that discharge the droplets of inks having colors of cyan, magenta, yellow, and black, respectively; a head holder 230 on which the respective inkjet heads 220C, 220M, 220Y, and 220K are mounted; and a moving mechanism (not shown) that moves the head holder 230.

Each of the inkjet heads 220C, 220M, 220Y, and 220K is formed of a line head corresponding to the maximum width (a width in an X direction) of the sheet 1 that is an object on which images are to be formed.

Each of the inkjet heads 220C, 220M, 220Y, and 220K is formed in the shape of a rectangular block, and nozzle surfaces 222C, 222M, 222Y, and 222K are formed on the bottoms of the inkjet heads, respectively. Further, the number and arrangement form of nozzles formed on each of the nozzle surfaces 222C, 222M, 222Y, and 222K are not particularly limited. Each of the inkjet heads 220C, 220M, 220Y, and 220K discharges ink from the nozzles by a piezoelectric method or a thermal method.

The head holder 230 includes head mounting parts (not shown) that are used to mount the inkjet heads 220C, 220M, 220Y, and 220K. The inkjet heads 220C, 220M, 220Y, and 220K are detachably mounted on the head mounting parts, respectively.

The respective inkjet heads 220C, 220M, 220Y, and 220K mounted on the head holder 230 are disposed so as to be orthogonal to the conveying direction of the sheet 1 (a Y direction). Furthermore, the respective inkjet heads are disposed at regular intervals in a predetermined order in the conveying direction of the sheet 1. In this embodiment, the respective inkjet heads are disposed in the order of cyan, magenta, yellow, and black.

The inkjet heads 220C, 220M, 220Y, and 220K are mounted on the head holder 230 so that the nozzle surfaces 222C, 222M, 222Y, and 222K thereof are parallel to a tangent to the peripheral surface of the conveying drum 210 facing the inkjet heads. That is, each of the nozzle surfaces 222C, 222M, 222Y, and 222K forms a certain angle with respect to the horizontal plane without being parallel to the horizontal plane.

The moving mechanism horizontally slides the head holder 230 in the X direction. The moving mechanism includes a ceiling frame that is horizontally installed over the conveying drum 210 and the moisture retention unit 240, a guide rail that is provided on the ceiling frame, a traveling body that slides on the guide rail, drive means (for example, a feed screw mechanism or the like) that moves the traveling body along the guide rail, and the like. The head holder 230 is mounted on the traveling body, and horizontally slides.

The head holder 230 is driven by the moving mechanism so as to be movable between an “image formation position” and a “moisture retention position”.

When the head holder 230 is present at the image formation position, the head holder 230 is disposed above the conveying drum 210. Accordingly, the inkjet recording device can record an image by discharging inks having the respective colors to the recording surface of the sheet 1 that is conveyed by the conveying drum 210.

Meanwhile, when the head holder 230 is present at the moisture retention position, the head holder 230 is disposed at a position where the moisture retention unit 240 is installed.

[Structure of Moisture Retention Cap]

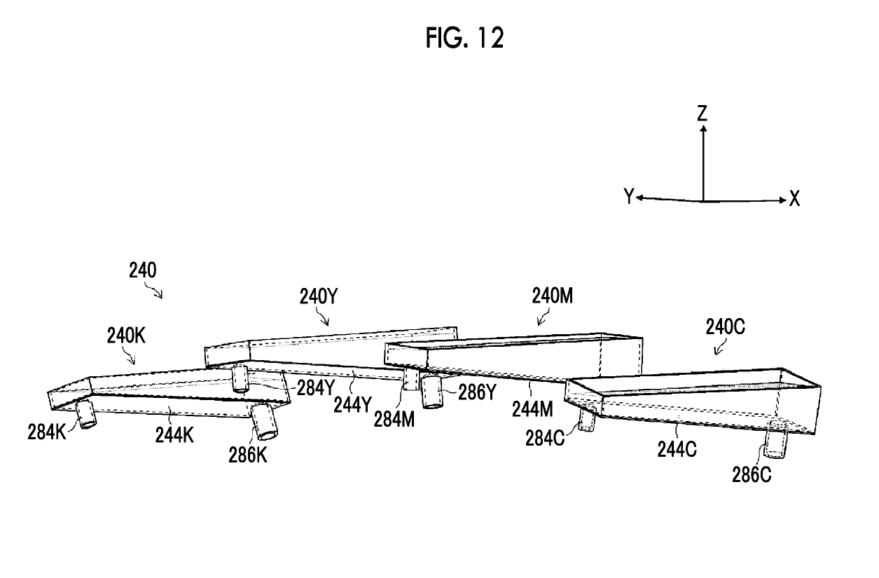

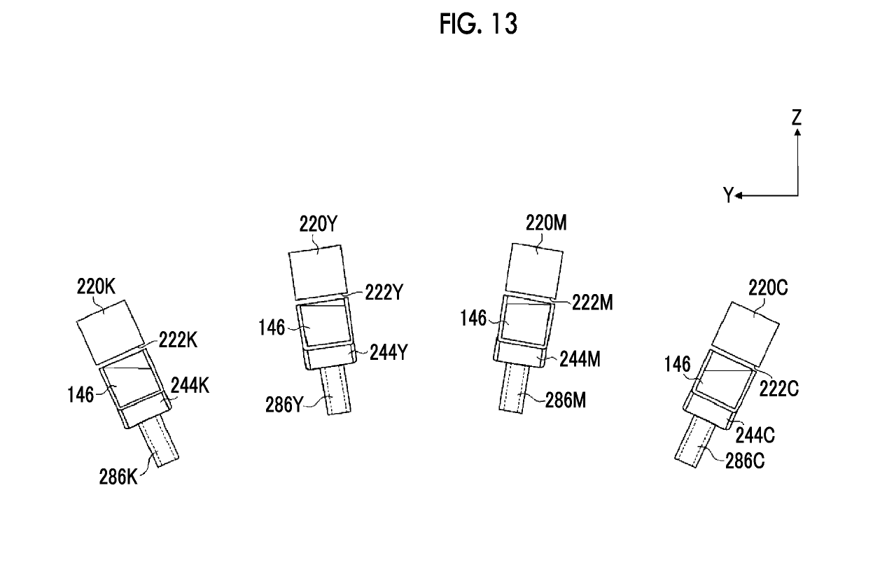

FIG. 12 is a perspective view of the moisture retention unit 240, and FIG. 13 is a view schematically showing the head unit 220 moved to the moisture retention position and the moisture retention unit 240 that is seen from the front (−X direction) side as a cross-section perpendicular to a width direction (X direction).

The moisture retention unit 240 includes moisture retention caps 240C, 240M, 240Y, and 240K that retain the moisture of the nozzle surfaces 222C, 222M, 222Y, and 222K of the inkjet heads 220C, 220M, 220Y, and 220K, respectively.

The insides (liquid storage portions) of the moisture retention caps 240C, 240M, 240Y, and 240K are filled with moisturizing liquid 146 that moisturizes the nozzle surfaces 222C, 222M, 222Y, and 222K of the inkjet heads 220C, 220M, 220Y, and 220K.

Further, the bottom surface 244C, 244M, 244Y, and 244K of the liquid storage portions are inclined with respect to a horizontal plane and a longitudinal direction of the inkjet heads 220C, 220M, 220Y, and 220K (the X direction in FIG. 12).

The moisture retention caps 240C, 240M, 240Y, and 240K include: moisturizing liquid supply lines 284C, 284M, 284Y, and 284K that supply moisturizing liquid 146 to the insides (the liquid storage portions) of the moisture retention caps 240C, 240M, 240Y, and 240K; and moisturizing liquid discharge lines 286C, 286M, 286Y, and 286K that discharge the moisturizing liquid 146 present in the insides (the liquid storage portions) of the moisture retention caps 240C, 240M, 240Y, and 240K, respectively.

Discharge ports of the moisturizing liquid discharge lines 286C, 286M, 286Y, and 286K are disposed at positions lower than the heights of supply ports of the moisturizing liquid supply lines 284C, 284M, 284Y, and 284K (positions lower than the heights of the supply ports in a vertical direction), and are provided on bottom surfaces 244C, 244M, 244Y, and 244K.

The respective moisture retention caps 240C, 240M, 240Y, and 240K are adapted so that the open surfaces of the moisture retention caps 240C, 240M, 240Y, and 240K are parallel to the nozzle surfaces 222C, 222M, 222Y, and 222K of the inkjet heads 220C, 220M, 220Y, and 220K.

Further, each of the moisture retention caps 240C, 240M, 240Y, and 240K is filled with the moisturizing liquid 146. Meanwhile, since the surface of the moisturizing liquid 146 is horizontal, the surface of the moisturizing liquid 146 is not parallel to the nozzle surfaces 222C, 222M, 222Y, and 222K. However, since the open surfaces of the moisture retention caps 240C, 240M, 240Y, and 240K are parallel to the nozzle surfaces 222C, 222M, 222Y, and 222K of the inkjet heads 220C, 220M, 220Y, and 220K, the humidity of each of the nozzle surfaces 222C, 222M, 222Y, and 222K can be maintained high and substantially uniform.

[Operation for Cleaning Inside of Moisture Retention Cap]

Also in the above-mentioned inkjet recording device according to the second embodiment, an operation for cleaning the inside of the moisture retention cap is the same as that of the first embodiment. That is, the liquid storage portion of the moisture retention cap, which stores the moisturizing liquid 146, includes the bottom surface that is inclined with respect to the horizontal plane and the longitudinal direction of the liquid discharge head. The liquid storage portion has the discharge port at a position, which is lower than the supply port for the moisturizing liquid 146, on the bottom surface. Accordingly, the moisturizing liquid contaminated with ink flows to the discharge port.

Further, since the liquid storage portion is cleaned by the same operation for cleaning the inside of the moisture retention cap as that of the first embodiment, the moisturizing liquid 146 of the liquid storage portion can become moisturizing liquid 146 that has less ink dirt and is clean to some extent. Accordingly, it is possible to shorten a cleaning time and to reduce the amount of moisturizing liquid to be used.

The moisturizing liquid 146, which is stored up to the first level h1 in the liquid storage portion, is discharged to the second level h2 from the discharge port (first step) and moisturizing liquid is then supplied from the supply port while the moisturizing liquid 146 continues to be discharged until the level of the moisturizing liquid becomes the third level h3 (second step). Turbulence is generated in the moisturizing liquid 146 of the liquid storage portion by the second step, and the moisturizing liquid 146 of the liquid storage portion is stirred and is discharged from the discharge port. Accordingly, since the liquid storage portion is cleaned, the moisturizing liquid of the liquid storage portion can become moisturizing liquid that has less ink dirt and is clean to some extent.

Further, when the moisturizing liquid 146, which has less ink dirt and is clean to some extent, is stored up to the third level h3 in the liquid storage portion, the discharge of the moisturizing liquid from the discharge port 175 is stopped and moisturizing liquid 146 is supplied until the level of the moisturizing liquid becomes the first level h1 (third step).

Accordingly, it is possible to shorten a cleaning time and to reduce the amount of the moisturizing liquid 146 to be used for the cleaning of the liquid storage portion.

In this specification, the inkjet recording device, which discharges coloring ink suitable for the printing of graphics, has been described as an example. However, the invention can be applied to an image forming device that discharges resist ink (heat-resistant covering material) for printed wiring, dispersion liquid in which conductive particulates are dispersed in a dispersion medium, ink used for manufacture of a color filter, and the like.

The technical scope of the invention is not limited to the scope described in the above-mentioned embodiments. The structures and the like of the respective embodiments can be appropriately combined with each other without departing from the gist of the invention.

### EXPLANATION OF REFERENCES

1: sheet
51: nozzle
66: supply port
68: discharge port
100, 200: inkjet recording device
120, 220C, 220M, 220Y, 220K: inkjet head
122, 222C, 222M, 222Y, 222K: nozzle surface
140, 240C, 240M, 240Y, 240K: moisture retention cap
142: liquid storage portion
144, 244C, 244M, 244Y, 244K: bottom surface
146: moisturizing liquid
160: moving mechanism (moving means)
173: supply port
175: discharge port
178: movement control unit
180: moisturizing liquid control unit (moisturizing liquid controller)
184, 284C, 284M, 284Y, 284K: moisturizing liquid supply line
186, 286C, 286M, 286Y, 286K: moisturizing liquid discharge line

What is claimed is:

1. A liquid discharge device comprising:
a liquid discharge head that includes a nozzle surface on which a plurality of nozzles discharging liquid are disposed;
a moisture retention cap that includes
a liquid storage portion including a bottom surface inclined with respect to a horizontal plane and storing moisturizing liquid,
a supply port supplying the moisturizing liquid to the liquid storage portion, and
a discharge port provided on the bottom surface so as to be disposed below the supply port and discharging the moisturizing liquid, and
retains the moisture of the nozzle surface;
a moving unit moving the liquid discharge head to an image formation position where the liquid discharge head discharges liquid to form an image on a medium and a standby position where moisture of the nozzle surface is retained; and
a moisturizing liquid controller controlling a level of the moisturizing liquid stored in the liquid storage portion,
wherein the moisturizing liquid controller
discharges the moisturizing liquid, which is stored up to a first level in the liquid storage portion, from the discharge port,
supplies moisturizing liquid from the supply port while discharging the moisturizing liquid from the discharge port when the level of the moisturizing liquid becomes a second level, and
stops the discharge of the moisturizing liquid from the discharge port while supplying moisturizing liquid from the supply port when the level of the moisturizing liquid becomes a third level.

2. The liquid discharge device according to claim 1,
wherein the moisturizing liquid controller supplies moisturizing liquid from the supply port until the level of the moisturizing liquid becomes the first level when the level of the moisturizing liquid becomes the third level.

3. The liquid discharge device according to claim 1,
wherein the moisturizing liquid controller controls the level of the moisturizing liquid on the basis of time that is calculated from capability to supply the moisturizing liquid and capability to discharge the moisturizing liquid.

4. The liquid discharge device according to claim 2,
wherein the moisturizing liquid controller controls the level of the moisturizing liquid on the basis of time that is calculated from capability to supply the moisturizing liquid and capability to discharge the moisturizing liquid.

5. The liquid discharge device according to claim 1, further comprising:
a level sensor that is provided on the liquid storage portion and detects the level of the moisturizing liquid stored in the liquid storage portion,
wherein the moisturizing liquid controller controls the level of the moisturizing liquid on the basis of a detected value of the level sensor.

6. The liquid discharge device according to claim 2, further comprising:
a level sensor that is provided on the liquid storage portion and detects the level of the moisturizing liquid stored in the liquid storage portion,
wherein the moisturizing liquid controller controls the level of the moisturizing liquid on the basis of a detected value of the level sensor.

7. The liquid discharge device according to claim 1, further comprising:
a humidity sensor that is provided on the nozzle surface of the liquid discharge head and detects humidity,
wherein the moisturizing liquid controller performs control of the level of the moisturizing liquid when a value of humidity lower than a predetermined value is detected in a case in which the liquid discharge head is present at the standby position.

8. The liquid discharge device according to claim 2, further comprising:
a humidity sensor that is provided on the nozzle surface of the liquid discharge head and detects humidity,
wherein the moisturizing liquid controller performs control of the level of the moisturizing liquid when a value of humidity lower than a predetermined value is detected in a case in which the liquid discharge head is present at the standby position.

9. The liquid discharge device according to claim 3, further comprising:
a humidity sensor that is provided on the nozzle surface of the liquid discharge head and detects humidity,
wherein the moisturizing liquid controller performs control of the level of the moisturizing liquid when a value of humidity lower than a predetermined value is detected in a case in which the liquid discharge head is present at the standby position.

10. The liquid discharge device according to claim 5, further comprising:
a humidity sensor that is provided on the nozzle surface of the liquid discharge head and detects humidity,
wherein the moisturizing liquid controller performs control of the level of the moisturizing liquid when a value of humidity lower than a predetermined value is detected in a case in which the liquid discharge head is present at the standby position.

11. The liquid discharge device according to claim 1,
wherein the moisturizing liquid controller performs control of the level of the moisturizing liquid at predetermined time intervals that is calculated on the basis of an evaporation time of the moisturizing liquid.

12. The liquid discharge device according to claim 1,
wherein the moisture retention cap further includes:
a moisturizing liquid tank that stores moisturizing liquid,
a moisturizing liquid supply unit supplying the moisturizing liquid, which is stored in the moisturizing liquid tank, to the liquid storage portion, and
a moisturizing liquid recovery tank that recovers the moisturizing liquid discharged from the liquid storage portion.

13. The liquid discharge device according to claim 12, further comprising:
a filter that removes contamination in the moisturizing liquid stored in the moisturizing liquid recovery tank; and
moisturizing liquid circulating means for supplying the moisturizing liquid, which has passed through the filter, to the moisturizing liquid tank.

14. A moisture retention cap that retains moisture of a nozzle surface of a liquid discharge head on which a plurality of nozzles discharging liquid are disposed, the moisture retention cap comprising:
a liquid storage portion that includes a bottom surface inclined with respect to a horizontal plane and stores moisturizing liquid;
a supply port that supplies moisturizing liquid to the liquid storage portion;
a discharge port that is provided on the bottom surface so as to be disposed below the supply port and discharges the moisturizing liquid; and
a moisturizing liquid controller controlling a level of the moisturizing liquid stored in the liquid storage portion,
wherein the moisturizing liquid controller discharges the moisturizing liquid, which is stored up to a first level in the liquid storage portion, from the discharge port, supplies moisturizing liquid from the supply port while discharging the moisturizing liquid from the discharge port when the level of the moisturizing liquid becomes a second level, and stops the discharge of the moisturizing liquid from the discharge port while supplying moisturizing liquid from the supply port when the level of the moisturizing liquid becomes a third level.

15. The moisture retention cap according to claim 14,
wherein the moisturizing liquid controller allows moisturizing liquid to be supplied from the supply port until the level of the moisturizing liquid becomes the first level when the level of the moisturizing liquid becomes the third level.

16. The moisture retention cap according to claim 14,
wherein the moisturizing liquid controller controls the level of the moisturizing liquid on the basis of time that is calculated from capability to supply the moisturizing liquid and capability to discharge the moisturizing liquid.

17. The moisture retention cap according to claim 15,
wherein the moisturizing liquid controller controls the level of the moisturizing liquid on the basis of time that is calculated from capability to supply the moisturizing liquid and capability to discharge the moisturizing liquid.

18. The moisture retention cap according to claim 14, further comprising:
a level sensor that is provided on the liquid storage portion and detects the level of the moisturizing liquid stored in the liquid storage portion,
wherein the moisturizing liquid controller controls the level of the moisturizing liquid on the basis of a detected value of the level sensor.

19. A method for cleaning the inside of a moisture retention cap including a liquid storage portion that includes a bottom surface inclined with respect to a horizontal plane and stores moisturizing liquid; a supply port that supplies moisturizing liquid to the liquid storage portion; and a discharge port that is provided on the bottom surface so as to be disposed below the supply port and discharges the moisturizing liquid, and retaining moisture of a nozzle surface of a liquid discharge head on which a plurality of nozzles discharging liquid are disposed, the method comprising:
a first step of discharging the moisturizing liquid, which is stored up to a first level in the liquid storage portion, to a second level from the discharge port;
a second step of continuing to discharge the moisturizing liquid and supplying moisturizing liquid from the supply port after the first step; and
a third step of continuing to supply the moisturizing liquid and stopping the discharge of the moisturizing liquid from the discharge port when the level of the moisturizing liquid becomes a third level.

20. The method for cleaning the inside of a moisture retention cap according to claim 19,
wherein in the third step, the moisturizing liquid is stored up to the first level when the level of the moisturizing liquid becomes the third level.
